(19) United States
(12) Patent Application Publication
(10) Pub. No.: US 2026/0037873 A1
(43) Pub. Date: Feb. 5, 2026

(54) COMBINING SEARCH, SELF-CRITIQUE AND REINFORCEMENT LEARNING FOR AUTONOMOUS WEB AGENTS

(71) Applicant: MultiOn, Palo Alto, CA (US)

(72) Inventors: Pranav PUTTA, Lake Forest, IL (US); Naman GARG, Palo Alto, CA (US); Divyansh GARG, Palo Alto, CA (US); Edmund MILLS, Affton, MO (US); Rafael Mitkov RAFAILOV, Stanford, CA (US)

(21) Appl. No.: 19/288,557

(22) Filed: Aug. 1, 2025

Related U.S. Application Data
(60) Provisional application No. 63/678,685, filed on Aug. 2, 2024.

(51) Int. Cl. G06N 20/00; G06F 18/21; G06N 3/048; G06N 3/084

(52) U.S. Cl. CPC G06N 20/00; G06F 18/2178; G06N 3/048; G06N 3/084

(57) ABSTRACT

Systems and methods include improved planning and reasoning capabilities of a web agent, which interacts with a real world website. The agent improves with autonomous experience and requires limited supervision. An MCTS-based search routine is deployed over web pages, a base model is used as an initial distribution, and a number of rationales and possible web actions are explored. AI feedback and self-criticism are used, and the model provides self-evaluation at each node.

### CROSS-REFERENCE TO RELATED APPLICATIONS

This application claims to the benefit of U.S. Provisional Patent Application No. 63/678,685, filed on Aug. 2, 2024, which is incorporated by reference herein in its entirety.

### FIELD OF THE DISCLOSURE

The present disclosure is directed to generating a model policy, specifically, to optimizing the generation of a model policy based on search, self-critique, and reinforcement learning for autonomous web agents.

### BACKGROUND

Models such as, for example, but not limited to, Large Language Models (LLMs) have shown remarkable capabilities in natural language tasks requiring complex reasoning. However, they struggle with generalizing to multi-step reasoning tasks in interactive environments like web navigation. This is primarily due to their pre-training on imitation learning datasets, which do not encompass the behaviors needed for interactive decision-making. Recent works have tried to overcome this challenge by supervised-fine tuning on curated expert demonstrations in such environments. However such behavior-cloning objectives suffer from compounding errors and yield sub-optimal policies due to limited exploration data. The recent successes of Large Language Models (LLMs) represent a significant leap in artificial intelligence. Frontier models like ChatGPT, Gemini, Opus, and LLaMA-3 demonstrate reasoning capabilities that approach average human performance in a number of domains. These breakthroughs have extended the utility of LLMs from traditional chat and purely text-based applications to more dynamic, agentic roles, in which they do not just generate text but can take actions autonomously in a number of environments including code and software engineering, device control, and web applications, among others.

What is needed is a model that generalizes effectively in interactive, multi-step environments, has improved reasoning and planning, makes use of interaction, such as, for example, but not limited to, user interaction, includes fine-tuning, fine-grained feedback, step-by-step verifiers or process reward models, and node-level optimization, using different branches produced by the search algorithm to create preference pairs. What is needed is a model that includes self-supervised search in combination with AI-based feedback and applied to a realistic web agent. What is needed is a planning and reasoning agent combined with a Monte Carlo tree search (MCTS) inference-time search and AI self-critique for self-supervised data collection, which is used for reinforcement learning (RL) (Direct Preference Optimization (DPO)) type training. Offline RL algorithms are designed for auto-regressive transformer models, and hence can be safely trained on pre-collected datasets, however they have not been successfully scaled to modern models. What is needed is to combine guided MCTS search and self-critique with iterative fine-tuning on agent interactions with an off-policy variant of the DPO algorithm. What is further needed is a method that enables model agents to learn effectively from aggregate datasets of both successful and unsuccessful trajectories, improving their generalization in multi-step reasoning tasks. What is still further needed is a method for validation of the model's learning where the validation makes use of the web environment, and where an agent navigates a simulated situation.

### SUMMARY

Systems and methods in accordance with embodiments of the present disclosure include improving planning and reasoning capabilities of a web agent, which interacts with a real world website. In a system and method in accordance with embodiments of the present disclosure, the agent improves with autonomous experience and requires limited supervision. The system and method combine improvements in reasoning, search, self-critique and reinforcement learning. In an embodiment of the system and method, an MCTS-based search routine is deployed over web pages, a base model is used as an initial distribution, and a number of rationales and possible web actions are explored. AI feedback and self-criticism are used, and the model provides self-evaluation at each node. To minimize errors, the traces generated by the search process are used to improve the zeroshot capabilities of the model with offline reinforcement learning using the DPO algorithm at each page-level, using different action branches to create preferences. These are scored using a mixture of the AI feedback rewards and the final success rate of the explored branch.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for generating an optimized model policy for one or more agents. The method includes (a) receiving an initial model policy, a replay buffer of trajectories, and an instruction, (b) determining a number of the trajectories for each instruction using the initial model policy, (c) constructing preference pairs at each of the nodes in each of the trajectories, (d) adding the preference pairs to the replay buffer, (e) updating the initial model policy creating an updated initial model policy based on the replay buffer, an executed plan of steps associated with the instruction executed in the updated initial model policy, a history of the executed plan and context of the executed plan, and the initial model policy. The method also includes (f) repeating steps (b)-(e) for a number of iterations to generate the optimized model policy based on the updated initial model policy. Other embodiments of this aspect include corresponding computer systems, apparatus, and computer programs recorded on one or more computer storage devices, each configured to perform the actions of the methods.

It is to be understood that both the foregoing general description and the following detailed description are exemplary and explanatory only and are not restrictive of the present teachings, as claimed.

### BRIEF DESCRIPTION OF THE DRAWINGS

The accompanying drawings, which are incorporated in and constitute a part of this specification, illustrate aspects of the present teachings and together with the description, serve to explain the principles of the present teachings.

FIG. 1 is a schematic block diagram of a system in accordance with embodiments of the present disclosure;

FIG. 2 is a schematic block diagram of a system including a MCTS and DPO in accordance with embodiments of the present disclosure;

FIG. 3 is a graphical illustration of the success rate of different approaches on the WebShop task. The base model is xLAM-v0.1-r;

FIG. 3 is a graphical illustration of the success rates of different approaches on the OpenTable benchmark;

FIG. 4 is an example of the agent's prompting and interaction with live websites;

FIGS. 5A-5H is an example of steps an agent takes to generate a correct plan and successfully clicks search bar and searches for the user restaurant; and

FIG. 6 is a flowchart of a method in accordance with embodiments of the present disclosure.

It should be noted that some details of the figures have been simplified and are drawn to facilitate understanding rather than to maintain strict structural accuracy, detail, and scale.

### DESCRIPTION

Reference will now be made in detail to the present teachings, examples of which are illustrated in the accompanying drawings. In the drawings, like reference numerals have been used throughout to designate identical elements. In the following description, reference is made to the accompanying drawings that form a part thereof, and in which is shown by way of illustration specific examples of practicing the present teachings. The following description is, therefore, merely exemplary.

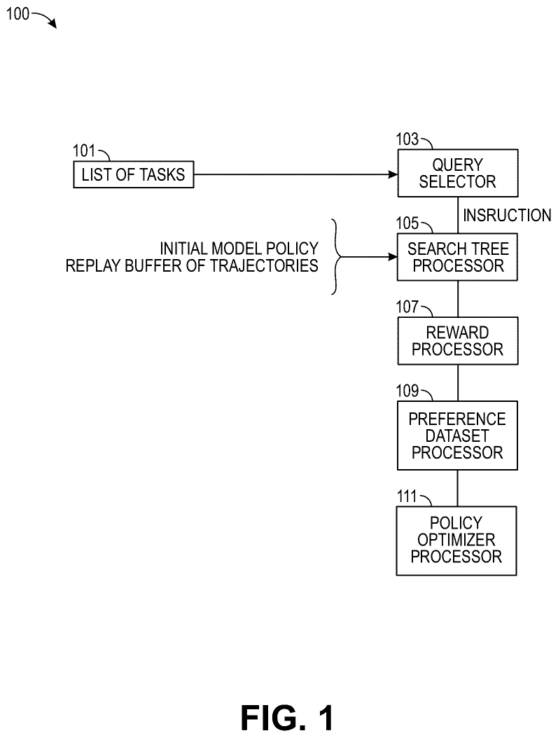

FIG. 1 illustrates a system in accordance with embodiments of the present disclosure. The system 100 may include a query selector 103 that samples a query (or instruction) from the list of possible tasks 101. The system 100 may include a search tree processor 105 that receives the instruction from the query selector 103, and an initial model policy and replay buffer of transactions. The search tree processor 105 iteratively expands a search tree associated with the instruction. The expansion includes balancing exploration with exploitation of possible actions associated with the search tree and the instruction. The reward processor 107 stores rewards obtained for each node in the search tree. The preference dataset processor 109 constructs a preference dataset, contrastive pairs are constructed, and the policy is optimized and may be iteratively improved by the policy optimizer processor 111.

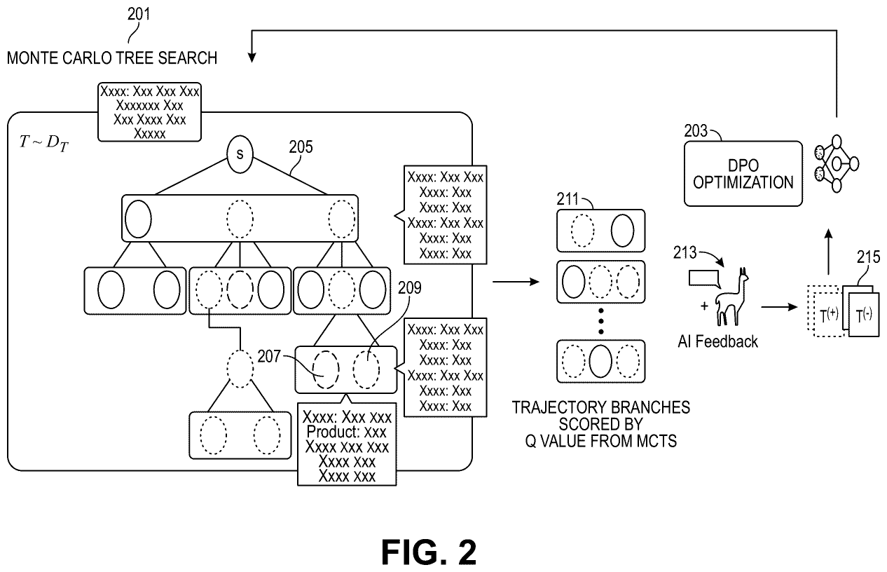

FIG. 2 is a block diagram of an embodiment of the system of FIG. 1 using MCTS and DPO. MCTS 201 guides trajectory collection and iteratively improves model performance using DPO 203. A user query is sampled from the list of tasks in the dataset DT. The search tree 205 is iteratively expanded using, for example, an upper confidence bound (UCB1) as a heuristic to balance exploration and exploitation of different actions. The accumulated reward obtained for each node in the tree is stored. For example, relatively higher reward 209 and relatively lower reward 207. To construct a preference dataset, a weighted score 211 of the MCTS average Q value is computed, and a score is generated by a feedback model 213 to construct contrastive pairs 215 for DPO 203. The policy may be optimized and iteratively improved by the feedback loop from the DPO 203 to the MCTS 201.

In some configurations, a partially observable Markov decision process (POMDP) may be used to develop the policy. The POMDP may be set up using parameters such as, for example, but not limited to, observation space ( [symbol] ), unobserved state space ( [symbol] ), action space ( [symbol] ) which is a set of possible alternative actions, transition distribution (T(Sₜ+1|sₜ, at)) which is a characterization of how the actions affect the states including resulting states and probabilities, a reward function (R(s, a)) which is a measure of the action's cost and/or state's value, initial state distribution (μ0(s0)) which is the agent's initial knowledge about the state, and discount factor (γ) which is how much an agent values future rewards versus immediate rewards. A POMDP is a framework to model web interactions in which the agent is unfamiliar with required exploration in order to locate the task objective, consistent with the meta-reinforcement learning as task inference view. Moreover, the real web is dynamic, which creates partial observability of the current state each time the agent is deployed. The agent may not a priori know a current state before attempting to take an action.

The agent observation oₜ ∈ [symbol] are instructions given by the user and the web browser. The first observation o1 in a reservation interaction may be a user text instruction, such as “Book reservation for a restaurant on a reservation website for 4 people on a date at a time” and a browser home page. Subsequent observations may include web pages from the browser, possibly represented through a compressed HTML document object model (DOM) format. The DOM is an application programming interface for HTML that defines a logical structure of documents. For some tasks the agent might ask for confirmation/feedback from the user, which may then become part of the observation. The agent actions at ∈ [symbol] are composite, based on agent history hₜ. In some configurations, a reasoning and acting (ReAct) agent with a preliminary planning step (PlanReAct) with additional components may be used. A ReAct agent is a framework for prompting large language models on tasks that require explicit reasoning and/or acting, deciding what actions to take using step-by-step reasoning.

With respect to planning, for the first action after the initial observation, the model's planning capabilities may be used to prompt the agent to generate a plan

$${a}_{1}^{plan} ∼ π ( {a}_{1}^{plan} \vert {h}_{1} )$$

of sequential steps to execute, such as, in the case of the reservation at a given restaurant on a given date at a given time for a given number of guests, (1) search for the restaurant on a reservation website, (2) navigate to the restaurant webpage, (3) Select the date and time for the reservation, choose the number of guests, and (5) make the reservation.

With respect to reasoning, actions may include a thought action

$${a}_{t}^{tht} ∼ π ( {a}_{t}^{tht} \vert {h}_{t} )$$

which is a reasoning step, such as “The user's objective is to book a reservation for a given number of guests at a given restaurant on a reservation website on a given date at a given time. Currently, I am on the reservation website homepage, and I don't see the restaurant listed. I need to search for the restaurant and navigate to its page to make a reservation.”

With respect to environmental action, a browser interaction command

$${a}_{t}^{env} \sim π ( {a}_{t}^{env} \vert {h}_{t} , {a}_{t}^{tht} )$$

may be generated which may include a set of options like “CLICK [ELEMENT ID]”, “SCROLL”, “TYPE [CONTENT]” and/or “ASK USER [CONTENT]”. This part of action generation may interact with the environment.

With respect to explanation action, after the environment interaction action has been

$${a}_{t}^{expl} ∼ π ( {a}_{t}^{expl} \vert {h}_{t} , {a}_{t}^{tht} , {a}_{t}^{env} )$$

generated, the model may be prompted for an explanation action such as “I am searching for a restaurant on a reservation website to navigate to its page and make a reservation for a given number of guests on a date at a time.” The step action denoted at is a tuple of plan, thought, environment, and explanation actions for the first step and thought, environment and explanation actions for subsequent steps. When optimizing models, the joint likelihood Eq. (1) states that

$$\begin{matrix}log π ( {a}_{1} \vert {h}_{1} ) = log π ( {a}_{1}^{expl} \vert {h}_{1} , {a}_{1}^{env} , {a}_{1}^{tht} , {a}_{1}^{plan} ) + log π ( {a}_{1}^{env} \vert {h}_{1} , {a}_{1}^{tht} , {a}_{1}^{plan} ) + \\ log π ( {a}_{1}^{tht} \vert {h}_{1} , {a}_{1}^{plan} ) + log π ( {a}_{1}^{plan} \vert {h}_{1} )\end{matrix}$$

for the initial action and

$$log π ( {a}_{t} \vert {h}_{t} ) = log π ( {a}_{t}^{expl} \vert {h}_{t} , {a}_{t}^{env} , {a}_{t}^{tht} ) + log π ( {a}_{t}^{env} \vert {h}_{t} , {a}_{t}^{tht} ) + log π ( {a}_{t}^{tht} \vert {h}_{t} )$$

for subsequent actions are computed.

The agent state is the current state of the web, which may not be observable. In the model, for example, the model resulting from formulating a POMDP policy, an agent memory component hₜ, is built. The history representation of the agent is built as hₜ=(a1, . . . , aₜ−1, Oₜ). The agent history may include the actions generated so far in the model execution process, and the current browser state. The agent thought and explanation actions may be constructed to act as a form of inner monologue that may represent the state and intentions of the agent. The environment action may affect the browser state, and the planning, reasoning, and explanation actions may affect subsequent decisions. Likelihoods over the composite action are computed when the agent is optimized.

With respect to fine-tuning models from feedback, reinforced fine-tuning (RFT) algorithms aggregate data and filter samples based on, for example, but not limited to, a reward model and/or a verifier to construct a dataset of trajectories [symbol] . Given this dataset and a parameterized model πθ, supervised fine-tuning (SFT) includes:

$$ℒ ( {π}_{θ} , 𝒟 ) = - {𝔼}_{𝒟} [ {\sum }_{t = 1}^{{T}_{i} - 1} log {π}_{θ} ( {a}_{{i}_{t}} ) \vert {h}_{{i}_{t}} ] \qquad ( 2 )$$

DPO is an offline RL algorithm, and an alternative to the classical reinforcement learning from human feedback (RLHF) optimization pipeline. DPO may be used to fine-tune an agent, using offline data and without online rollouts. In a text generation setting, DPO considers feedback of pairwise comparisons (s, aw, al), where s is a single prompt and aw and al are two responses with aw>al indicating that aw is preferred over al.

```
Algorithm 1 Iterative DPO With A Replay Buffer
  Input: π_{θ}_{_{O}}, begin with an initial LLM policy and replay buffer [symbol]
  Output: π_{θ}, the trained LLM policy
  for i = 1 to N do
    $Collect K trajectories per prompt {\{ {τ}^{i} \}}_{i = 1}^{K} using {π}_{{θ}_{i}} from the$
    environment.
    Construct preference pairs {(τ^{w}, τⁱ), (log π_{θ}_{ᵢ}(τ^{w}), log π_{θ}_{ᵢ}(τⁱ))}
    and add them to [symbol]
    Optimize π_{θ}_{ᵢ₊₁} with data from [symbol]   (including reference log-
    probabilities) using Eq. 3
  end for
```

$${ℒ}_{DPO} ( {π}_{θ} ; 𝒟 ) = - {𝔼}_{( {T}_{ω} , {T}_{l} ) \sim 𝒟} [ log σ ( ( {\sum }_{t = 0}^{{i}_{⊤} ω - 1} β log \frac{{π}_{θ} ( {a}_{t}^{ω} \vert {h}_{t}^{ω} )}{{π}_{ref} ( {a}_{t}^{ω} \vert {h}_{t}^{ω} )} ) - ( {\sum }_{t = 0}^{{i}_{⊤} ↓ - 1} β log \frac{{π}_{θ} ( {a}_{t}^{l} \vert {h}_{t}^{l} )}{{π}_{ref} ( {a}_{t}^{l} \vert {h}_{t}^{l} )} ) ) ] \qquad ( 3 )$$

where D is the replay buffer of the trajectories, E is an expectation average operator, σ is a sigmoid function, β is a temperature parameter, aₜ is a plan of steps associated with the instruction executed in the updated initial model policy, hₜ is the history of the executed plan and the context of the executed plan, πθ is the updated initial model policy (an optimized model policy), π_{ref} is the initial model policy, and t is an iteration number. π^{ref} is a reference distribution (for example, the base model being fine-tuned) which is suited to the agentic setting. The algorithm uses an off-policy replay buffer, which may aggregate trajectory data, as well as likelihoods of the generated actions. During the optimization step, tuples of trajectories may be sampled and the corresponding likelihoods under the data generation (reference) density are sampled, which may eliminate the need for a separate reference model.

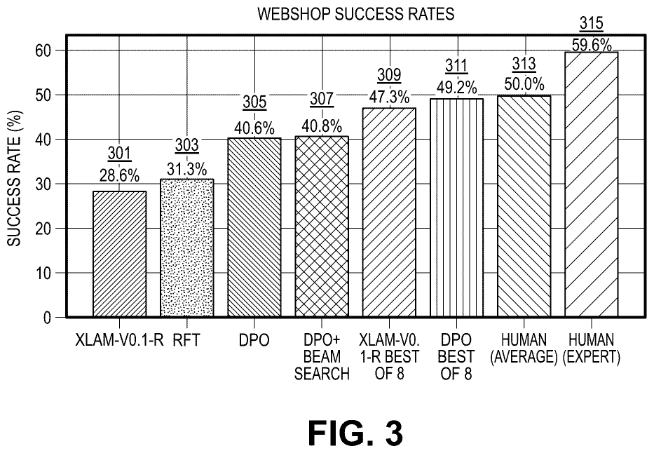

Referring now to FIG. 3, in experimental use, an AgentOhana xLAM-v0.1-r model, which is a fine-tune of a pre-trained Mixtral-8x7B-Instruct-v0.1 model (a pre-trained generative sparce mixture of experts) on a mix of agentic applications, including WebShop SFT data used for SFT of AI models, is used. AgentOhana standardizes and unifies agent trajectories for consistent training, enhancing performance with the xLAM-v0.1 large action model across diverse data sources. WebShop is a simulated e-commerce website environment having products available for acquisition and crowd-sourced text instructions. An agent interfacing with this environment may navigate multiple types of webpages and issue diverse actions to find, customize, and purchase a product given an instruction. An agent configuration specified by, for example, AgentLite may provide a comparison between a fine-tuned model and base model performance. AgentLite may be used to streamline the development of AI agents using large language models. The environment comes with a pre-selected number of pre-defined tasks corresponding to specific products to find. The pre-defined tasks may be split into a set of tasks used to train the model. The set of tasks may be used for agent fine-tuning. A set of held-out tasks may be used for zero-shot evaluation. Success rates (exact product match) are shown for different approaches in FIG. 3. The base xLAM-v0.1-r model 301 achieves a success rate of 28.6% on the test tasks. The other methods shown in the graph are based on outcome-based supervision, depending on whether a particular attempt was successful or not. The RFT model 303 uses a STaR-like algorithm on the trajectory level and achieves a success rate of 31.3%. When the base model is fine-tuned using a trajectory-level DPO algorithm 305, and outcome-level supervision and failed trajectories are used, the agent performance is improved over the RFT agent success rate. Another model 307 is evaluated with beam search for the action generation, which can be considered a form of planning the horizon of an environment action (which consists of multiple actions). A “Best-of-N” (N=8 for example) approach is evaluated, which is a rejection-sampling based method, that generates N independent samples from the model and filters out the best one based on certain criteria. This technique comes with theoretical guarantees and an inference cost.

When a pre-selected number of trajectories, for example eight, per task are sampled, and the task is considered successful if any of the attempts to purchase the correct product are successful. The base model 309, without any additional training achieves a success rate of 47.3% in this configuration, while the DPO-tuned model 311 achieves success of 49.2%, coming close to the 50% success rate of average human performance 313, and the 59.6% success rate of human expert performance 315. This is better performance than zero-shot deployment of the RL-tuned RFT and DPO models, which is contrasted to RLHF settings, where usually RL-tuned models are capable of matching performance of the best-of-N strategy. These results indicate that there is a difference between the web agent and chat setting in terms of inference-time optimization. One of the core failure modes of the DPO policy is that it executes a greedy search when looking for matches to the product query. For example, for a search query, the WebShop environment yields a number of pages of results. The model greedily searches for the best matching item in the first page of results rather than using the “[NEXT]” and “[PREV]” buttons to navigate between pages.

With respect to combining search and RL, a guided search strategy, for example, but not limited to, the MCTS, for data collection and AI feedback to generate process supervision at the step level may be used. The guided search strategy may use a mathematical framework to guide the iterative preference learning effectively. For example, MCTS includes four phases: selection, expansion, simulation, and backpropagation. Each phase plays a role in balancing exploration and exploitation while iteratively refining the policy.

The selection phase may select nodes by balancing exploration and exploitation, for example, but not limited to, using the Upper Confidence Bound (UCB1) formula:

$${a}_{t + 1}^{+} = arg {max}_{a} [ Q ( {s}_{t} , a ) + {c}_{exp} \cdot \sqrt{\frac{log N ( {s}_{t} )}{1 + N ( {s}_{t + 1} )}} ]$$

where Q (St, a) represents the estimated value of taking action a in state Sₜ, N(Sₜ) is the visitation frequency of state Sₜ, and Cₑₓₚ is an exploration constant, a parameter that controls how much an agent explores its environment versus exploiting its current knowledge. For each rollout added to the tree, the root node is the starting place, and the child states that maximize the UCB1 score follow until a leaf node is reached. This process is repeated for each tree/prompt in the batch.

In the expansion phase, web interactions have a free-form nature. To sample the space of actions, K completions are generated from the policy to expand the given state. To effectively learn from self-generated data, a diverse set of explored actions is used at each state. Generation diversity using a high sampling temperature and instructions are used to generate creative actions in the system prompt to improve the diversity of actions.

Once actions are expanded, the simulation and backpropagation phase begins. Beginning from the selected state node's trace, the trajectory is rolled out using the current policy πθ until a terminal state is reached. The environment returns a reward at the end of the trajectory, R. This reward, multiplied by some discount factor, γ, is propagated by updating the values of each node bottom up from the leaf node to the root as follows:

$$\begin{matrix}Q ( {s}_{t} , a ) ← \frac{Q ( {s}_{t} , a ) N ( {s}_{t} , a ) + {γ}^{T - t} R}{N ( {s}_{t} , a ) + 1} \\ N ( {s}_{t} , a ) ← N ( {s}_{t} , a ) + 1\end{matrix}$$

where γ is the discount factor for future state values. Each state node tracks two values: Q(st, a), the average reward for passing through state sₜ and choosing action a, and N(St, a), the number of times this state action pair was visited during search. The back propagation updates maintain these values.

AI-collected feedback is incorporated to provide process supervision at the step level to enhance the quality of the preference pairs that may be used for training. In some configurations, the LLaMA-3-70B-Instruct model is used to produce a feedback score for each action by asking it to rank the generated actions by its perceived utility in helping the agent complete the user task. The following prompt may be used: “{System Prompt} Rather than generate an action for the instructions above, choose between the following actions. Each action has been given feedback, which is also provided. Actions and Feedback: {Generated Actions and Feedback} Select the better action. Give your answer as JSON, with the keys ‘reasoning’ and ‘ranking’. The value of ‘ranking’ should be an integer corresponding to the best action. The value of ‘reasoning’ should be a string explaining your reasoning for the ranking. Reflect on the feedback provided for each action.” The feedback model may be queried for multiple iterations, each time removing the best action selected from the previous iteration from the list, until a full ranking of the actions is achieved. The resulting score for each action is recorded as F (St). To construct the preference dataset for policy improvement, each inner node in the MCTS is evaluated, and an attempt is made to find contrastive pairs. Each child node receives a score based on two components: the Q value from the MCTS iteration and the LLM feedback score. The LLM feedback score is derived from the prompt described herein, and provides an additional evaluation layer. Using the ordering generated from the LLM prompt, an F (St) score is assigned to each child state. The total Q value at each state is then a weighted sum of the original Q value and the feedback score:

$${Q}^{′} ( {s}_{t} , a ) = α Q ( {s}_{t} , a ) + ( 1 - α ) F ( {s}_{t} ) .$$

The average Q value is computed, normalized by visitation count for each node, and pairs are constructed where the positive sample branch has a reward at least greater than a threshold value Qₘᵢₙ. By comparing each pair of nodes if there are k children,

$$( \begin{matrix}k \\ 2\end{matrix} ) :$$

pairings are considered), higher reward trajectories and lower reward trajectories are identified to form pairs. Once the preference dataset is collected, the DPO is applied over the pairings to fine-tune the final model.

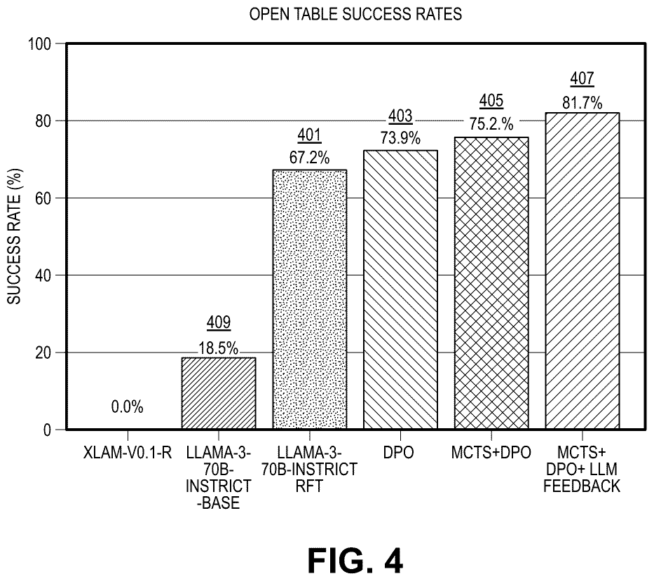

Referring now to FIG. 4, for the set of experiments, the method is tested over the Webshop environment and an environment such as, for example, OpenTable.

```
Algorithm 2 MCTS Guided Direct Preference Optimization
  Input: π_{θ}_{_{O}}: initial LLM policy, [symbol] ᵣ: dataset of tasks the agent must
  complete in the environment, N:
  Number of iterations, B: Number of samples per iteration, T: MCTS
  tree depth, [symbol]  : replay buffer,
  K: Number of actions to sample for MCTS
  Output: π_{θ}_{_{N}}, the trained LLM policy
  for i = 1 to N do
    π_{ref} ← π_{θ}_{ᵢ}, π_{θ}_{ᵢ} ← π_{θ}_{_{i−1}}
    Sample a batch of B tasks from [symbol]  _{T}
    for each task in batch do
      Initialize the root node s₀
      for t = 1 to T do
        Selection: Traverse the tree from the root node to a leaf node
        using tree policy (UCB1)
        Expansion: If the leaf node is not a terminal state, sample K
        actions from policy
        Simulation: Simulate the rollout from the expanded node to
        obtain a value estimate
        Backpropagation: Backpropagate the value estimate
        bottom-up
      end for
      Collect trajectories from rollouts and store them in replay buffer

[symbol]

    end for
    $Construct preference pairs 𝒫 = {\{ ( {s}_{t} , {a}_{w}^{〈 t 〉} , {a}_{l}^{〈 t 〉} ) \}}_{t = 1}^{T - 1} where {s}_{t} \sim {𝒟}_{p} .$
  For each node at step level t, compare each pair of child nodes, and
  construct the pair of generated actions (a_{w}, aₜ) if the values of taking
  the action, |Q′(sₜ, a_{w}) V − Q′(sₜ, oₗ)| > θ_{threshold}
    Optimize LLM policy π_{θ}_{ᵢ} using DPO objective with [symbol]   and π_{ref}
  end for
```

In OpenTable, the agent is tasked with booking a restaurant reservation for a user. The agent finds a restaurant page on the OpenTable site, look for a reservation at a certain date and time, choose seating options that align with a user's preference and submit the user contact information to complete the task successfully. Since OpenTable is a live environment and is difficult to programmatically measure metrics for, a language model, GPT-4-V, is used to collect sub-rewards for each trajectory, based on the following metrics: Date and Time set correctly, Party Size set correctly, User information entered correctly, clicked complete reservation. Task completion is measured by the above properties being satisfied. To generate queries for the OpenTable benchmark dataset, a diverse set of user queries is programmatically generated by combining the restaurant name, desired date and time, and user information. Navigating on live websites poses a wide variety of challenges. Some examples include: (1) if the user specifies a restaurant in a different city than the location the browser is initialized in, the model may take extra steps to find the restaurant; (2) if the exact user requested date and time are not available, the model may choose the closest available reservation slot; and/or (3) if there are preferences, such as indoor or outdoor seating options that the model is presented with, the desired behavior is to interact with the user to determine the best course of action. OpenTable presents a set of challenges for web navigation agents. The number of steps required to complete the task is on average 13.9 steps, over double the average number of steps for Webshop, 6.8. Collecting data via MCTS and improving the policy via DPO can significantly boost performance of the model. For the observation space for this environment, a condensed state representation is designed that crawls the raw HTML content of a website to retrieve relevant visual components, and highlights interactive elements to the model. The agent is allowed the actions, “CLICK [ID]”, “GOTO [URL]”, “TYPE [ID] [TEXT]”, “SUBMIT [ID]”, “CLEAR [ID]”, “SCROLL [UP/DOWN]”, and “ASK USER HELP”. For OpenTable experiments, the LLaMA-3-70B-Instruct model 401 is used as the initial policy. The reasoning abilities of this class of model is used to produce the diverse success and failure trajectories for improving the policy using DPO.

In another set of experiments, the iterative DPO method 403 is extended by collecting data via guided search (MCTS) as described herein. The DPO method 403 provides iterative policy improvement. Two different ablations are conducted for collecting data in the Webshop environment, where the number of sampled actions per node is changed during the MCTS expansion phase. MCTS guided sampling improves Web Shop performance. Larger branching factor rollouts boost performance. With the branching factor, k, set to 3, there is a performance improvement to 42.03% success rate. When k is set to 5, there is a performance of up to 42.4% success rate. In Webshop, due to the model's tendency to select products in the first set of search results, it is possible that the improvement from higher branching comes from more effective search queries that the model learns to prioritize, as well as learning to inspect products in more detail before selecting them.

MCTS enables improvements in performance over the base policy 409 in the OpenTable environments. Since the condensed DOM representations that are designed for general websites are too large to fit multiple observations in a single context, ReAct prompting is not used in this experiment. The agent is provided with the system prompt, condensed summary of action history, and the current observation. Three experiments were conducted in the OpenTable environment, first using outcome supervision DPO 403 as we did with Webshop, MCTS without LLM feedback 405 during preference pair construction, and MCTS with LLM feedback 407. Due to the larger action space and more diverse observations, the language model agent was incentivized to produce diverse actions for node expansion. From the supervised fine-tuned model performance, MCTS and DPO without LLM feedback yields a gain from 67% success rate to 75.2%, and with LLM feedback, there is a gain of 67% to 81.7% in success rate.

A system and method in accordance with embodiments of the present disclosure include algorithms for autonomous improvement of web-agents with limited human supervision. While prior works build frameworks around existing models without additional training, the system and method fine-tune pre-trained models for web navigation tasks based on synthetic data. The DPO algorithm is extended to multi-turn planning and reasoning interactive agents. Using the system and method, performance on a simulated web shopping environment is improved. Combining guided MCTS search over the web in combination with step-level AI self-critique for data generation improves success rate. Deploying a DPO feedback optimization at branch-level boosts the performance of the website agent by close to 15% total success rate.

As an example of the agent's input from the environment which includes a system prompt about the rules that the agent follows, shown are an execution history which is a condensed history of actions that the agent has executed in prior steps and the current observation which is a condensed representation of the HTML DOM. The agent output involves an optional plan, chain of thought, and the finally the list of commands that the agent outputs.

You are an intelligent agent. You should follow your [Role], [Action_Doc] to take
actions. Your generation should follow the example format. Finish the task as best
as you can.
[Role]
You can interact with the webshop.
[End of Role]
[Constraint]
You generation should be simple and clear.
[End of Constraint]
[Action_Doc]
[{‘name’: ‘search’, ‘description’; ‘search for a product in the webshop’,
‘parameters': {‘product’: ‘the name of the product to search for’}}, {‘name’:
‘Finish’, ‘description’; ‘Complete the task with a response.’, ‘parameters':
{‘response’: ‘this is the finish action response. Respond towards the task
instruction,’}}, {‘name’: ‘Think’, ‘description’: ‘Conduct thinking and reasoning
process for solving task.’, ‘parameters': {‘response’: ‘this is your thinking
response. Be specific and critical.’}}, {‘name’: ‘click’, ‘description’: ‘click a
button in the web page’, ‘parameters': {‘button’: ‘the name of the button to
click’}}]
[End of Action_Doc]
[Example]
Task:i would like a 3 ounce bottle of bright citrus deodorant for sensitive skin,
and price lower than 50.00 dollars
Action:Think[{“response”: “I should first use Search to search bright citrus
deodorant for sensitive skin.”}]
Observation: OK
Action:search[{“product”: “bright citrus deodorant for sensitive skin”}]
Observation: WEB PAGE: {
[Back to Search]
Page 1 (Total results: 15)
[Next >]
[B078GWRC1J]
Bright Citrus Deodorant by Earth Mama | Natural and Safe for Sensitive Skin,
Pregnancy and Breastfeeding, Contains Organic Calendula 3-Ounce
$10.99
[B08KBVJ4XN]
Barrel and Oak - Aluminum-Free Deodorant, Deodorant for Men, Essential Oil-Based
Scent, 24-Hour Odor Protection, Cedar & Patchouli Blend, Gentle on Sensitive Skin
(Mountain Sage, 2.
7 oz, 2-Pack)
$15.95
[B08KC3QXZW]
Barrel and Oak - Aluminum-Free Deodorant Variety Pack, Deodorant for Men, Natural
Fragrance, 3 Essential Oil-Based Scents, For Sensitive Skin, No Clothing Stains,
Vegan (3 oz Per De
odorant, 3-Pack)
$26.95)
Action:Think[{“response”: “The first product is most relevant to the requirements. I
should click the first product.”}]
Observation: OK
Action:click[{“button”: “B078GWRC1J”}]
Observation: WEB PAGE: {
[Back to Search]
[< Prev]
scent [assorted scents][bright citrus][calming lavender][ginger fresh][simply
non-scents]
size [3 ounce (pack of 1)]}
Action:click[{“button”: “bright citrus”}]
Observation: “You have clicked bright citrus.
Action:click[{“button”: “3 ounce (pack of 1)”}]
Observation: “You have clicked 3 ounce (pack of 1).
Action:click[{“button”: “Buy Now”}]
Observation: “You have bought the product.
Action:Finish[{“response”: “Task Finished. Reward: 1.0”}]
Observation: “You have finished the shopping. Reward: 1.0
[End of Example]
[Execution]

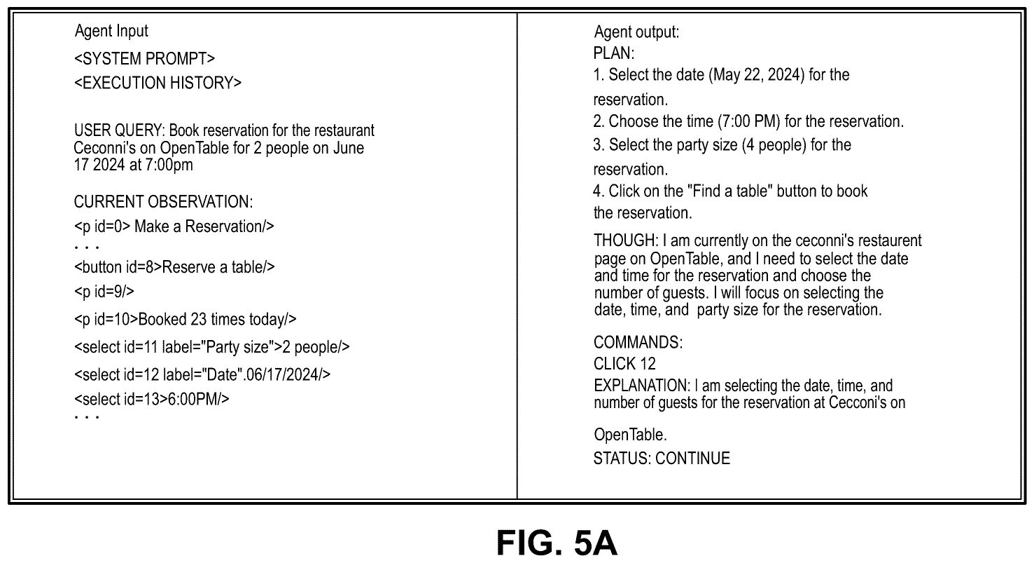

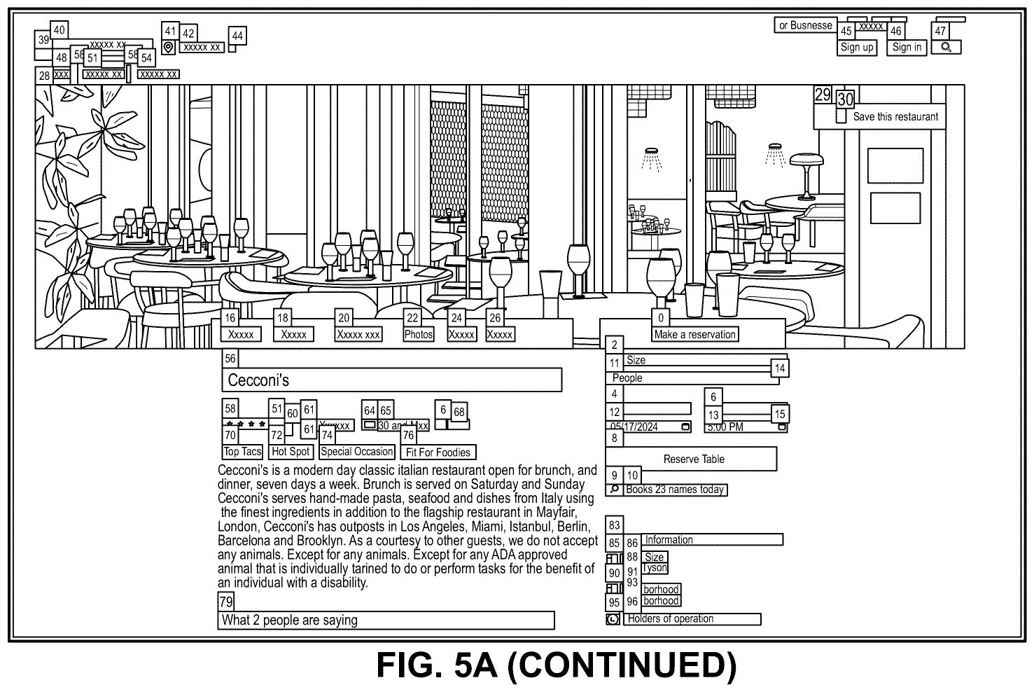

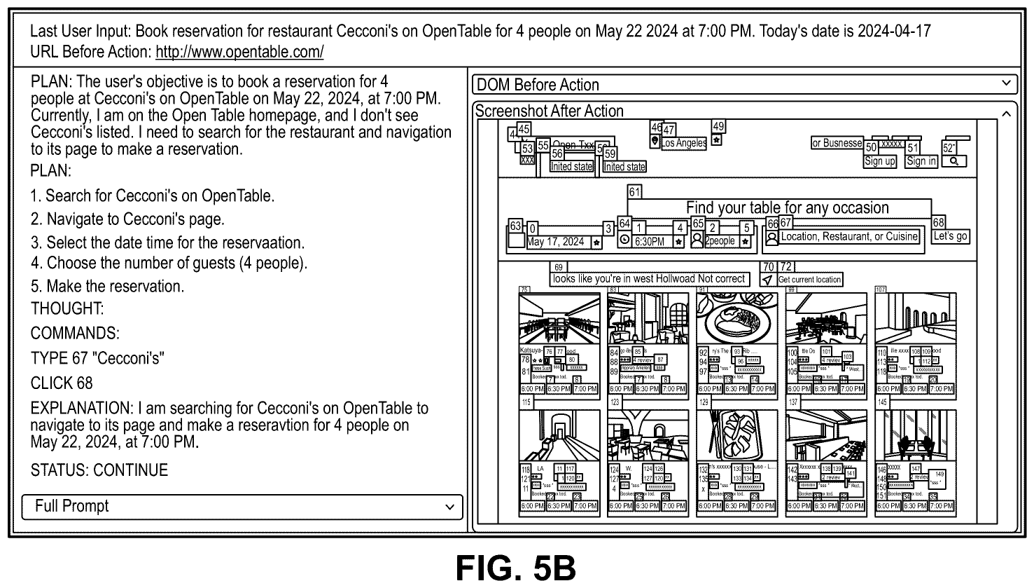

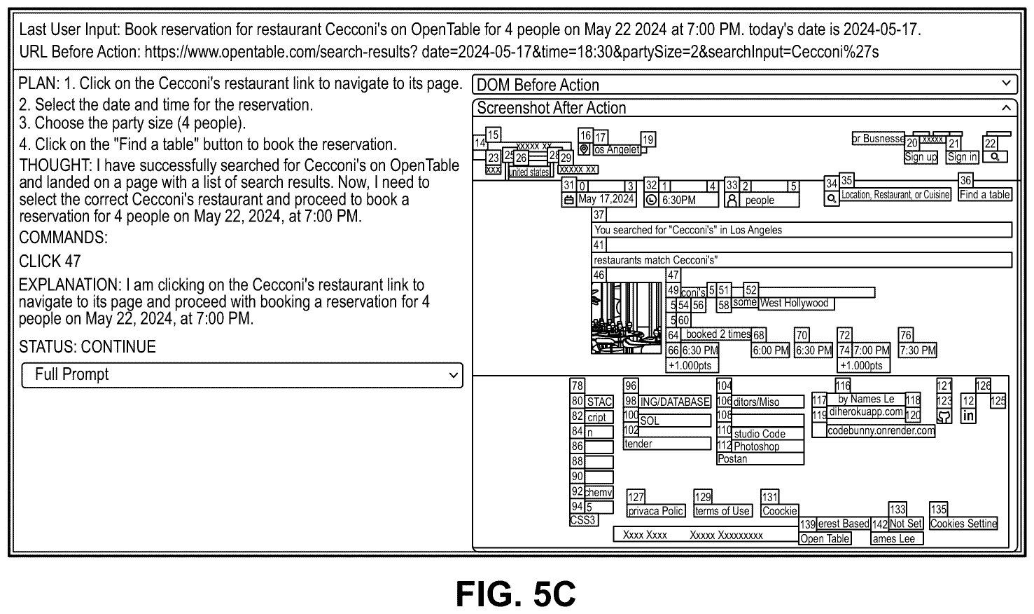

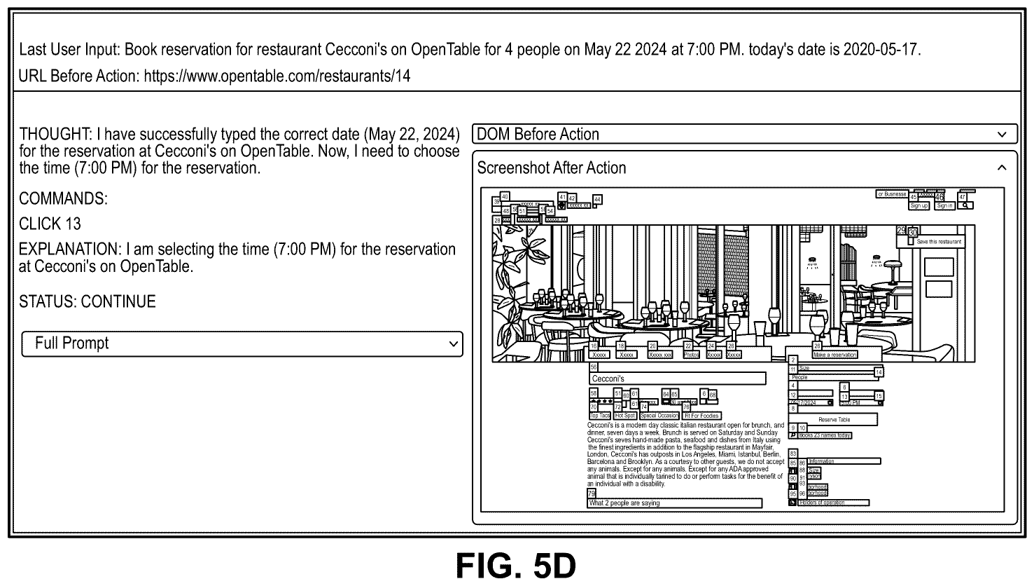

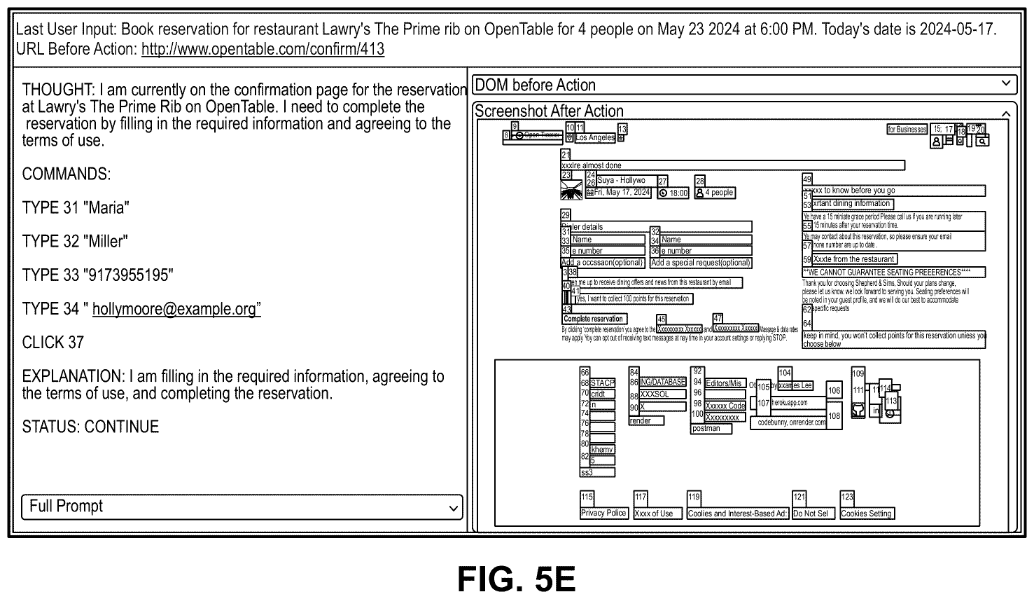

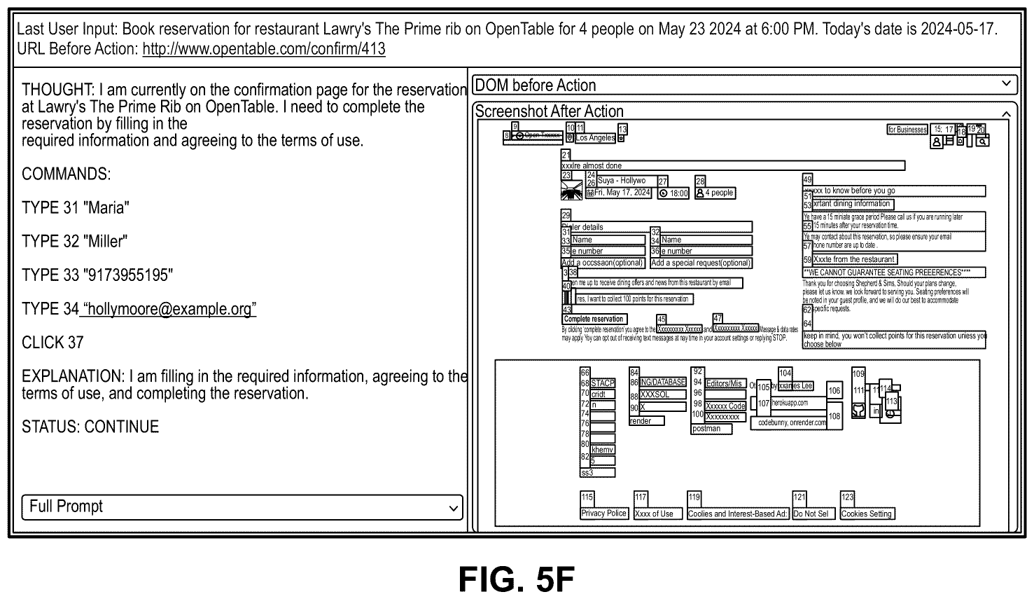

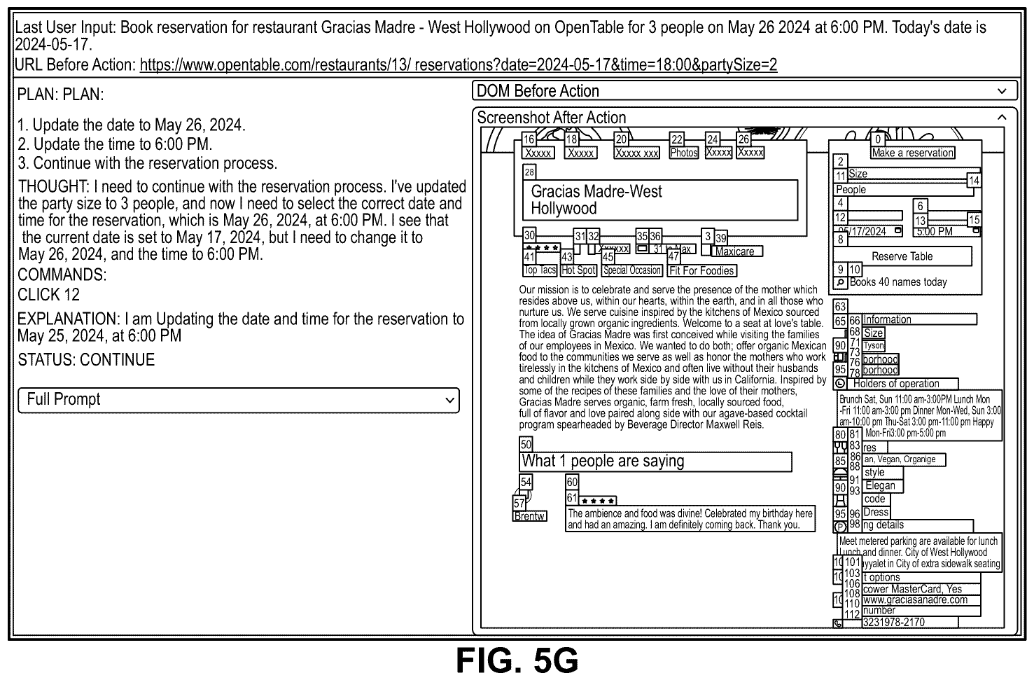

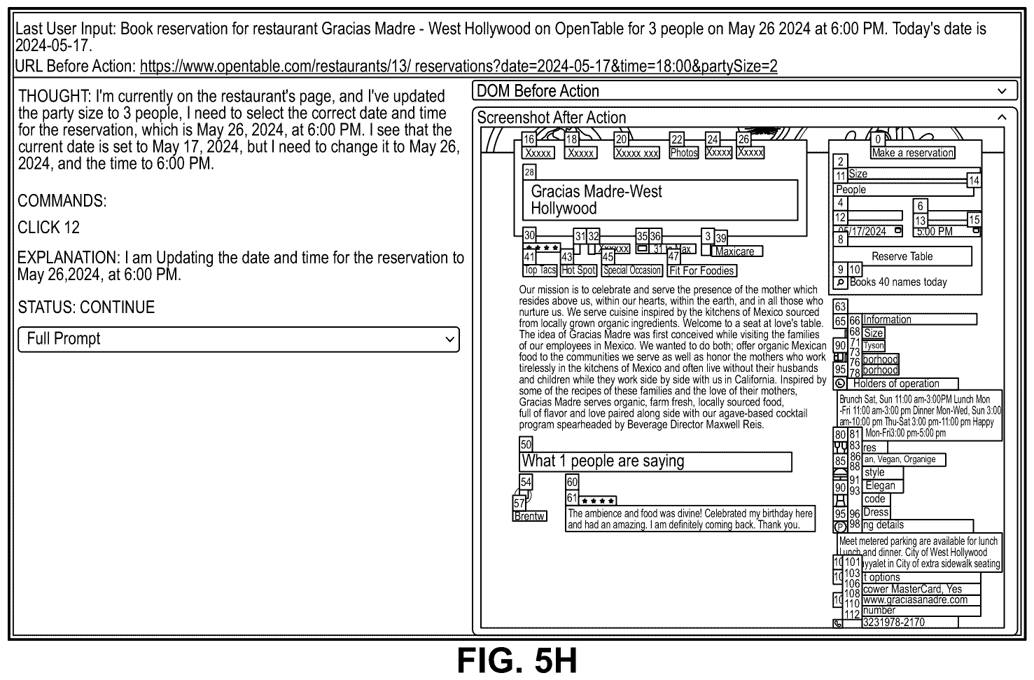

Referring now to FIGS. 5A-5H, shown are examples of the agent's prompting and interaction with a live website. In step 1 (FIG. 5B), the agent generates a plan and successfully clicks the search bar and searches for the requested restaurant. In step 2 (FIG. 5C), the agent clicks on the correct restaurant. In steps 3-7 (FIGS. 5D-5H), the agent modifies the party size, date, and time to match the user request. In step 4 (FIG. 5E), the agent thinks it has set the date and time, but has only set the search query date/time. In step 5 (FIG. 5F), the agent does not realize the search query date and time has not applied to the actual reservation. In step 6 (FIG. 5G), the agent continues clicking element ID 12, expecting something to change in the environment, but is clicking on the textbox. In step 7, (FIG. 5H), the agent continues to click the same button in a loop.

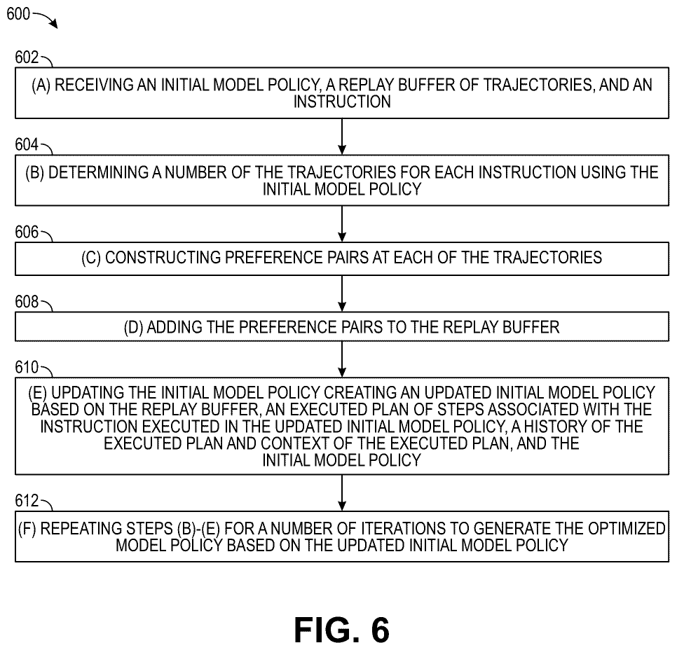

Referring now to FIG. 6, a method 600 for generating an optimized model policy for one or more agents in accordance with embodiments of the present disclosure includes, but is not limited to including, receiving 602 an initial model policy, a replay buffer of trajectories, and an instruction, determining 604 a number of the trajectories for each instruction using the initial model policy, constructing 606 preference pairs at each of the nodes in each of the trajectories, adding 608 the preference pairs to the replay buffer, updating 610 the initial model policy creating an updated initial model policy based on the replay buffer, an executed plan of steps associated with the instruction executed in the updated initial model policy, a history of the executed plan and context of the executed plan, and the initial model policy and repeating 612 steps 604-610 for a number of iterations to generate the optimized model policy based on the updated initial model policy.

While the present teachings have been illustrated with respect to one or more implementations, alterations and/or modifications can be made to the illustrated examples without departing from the spirit and scope of the appended claims. In addition, while a particular feature of the present teachings may have been disclosed with respect to only one of several implementations, such feature may be combined with one or more other features of the other implementations as may be desired and advantageous for any given or particular function. As used herein, the terms “a”, “an”, and “the” may refer to one or more elements or parts of elements. As used herein, the terms “first” and “second” may refer to two different elements or parts of elements. As used herein, the term “at least one of A and B” with respect to a listing of items such as, for example, A and B, means A alone, B alone, or A and B. Those skilled in the art will recognize that these and other variations are possible. Furthermore, to the extent that the terms “including,” “includes,” “having,” “has,” “with,” or variants thereof are used in either the detailed description and the claims, such terms are intended to be inclusive in a manner similar to the term “comprising.” Further, in the discussion and claims herein, the term “about” indicates that the value listed may be somewhat altered, as long as the alteration does not result in nonconformance of the process or structure to the intended purpose described herein. Finally, “exemplary” indicates the description is used as an example, rather than implying that it is an ideal.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompasses by the following claims.

1. A method for generating an optimized model policy for one or more agents, the method comprising:
(a) receiving an initial model policy, a replay buffer of trajectories, and an instruction;
(b) determining a number of the trajectories for each instruction using the initial model policy;
(c) constructing preference pairs at each node in each of the trajectories;
(d) adding the preference pairs to the replay buffer;
(e) updating the initial model policy creating an updated initial model policy based on the replay buffer, an executed plan of steps associated with the instruction executed in the updated initial model policy, a history of the executed plan and context of the executed plan, and the initial model policy; and
(f) repeating steps (b)-(e) for a number of iterations to generate the optimized model policy based on the updated initial model policy.

2. The method of claim 1, wherein updating the initial model policy is based on
$${ℒ}_{DPO} ( {π}_{θ} ; 𝒟 ) = - {𝔼}_{( {T}_{ω} , {T}_{l} ) \sim 𝒟} [ log σ ( ( {\sum }_{t = 0}^{{i}_{⊤} ω - 1} β log \frac{{π}_{θ} ( {a}_{t}^{ω} \vert {h}_{t}^{ω} )}{{π}_{ref} ( {a}_{t}^{ω} \vert {h}_{t}^{ω} )} ) - ( {\sum }_{t = 0}^{{i}_{⊤} ↓ - 1} β log \frac{{π}_{θ} ( {a}_{t}^{l} \vert {h}_{t}^{l} )}{{π}_{ref} ( {a}_{t}^{l} \vert {h}_{t}^{l} )} ) ) ]$$
where D is the rep −E( [symbol] )˜D he trajectories, E is an expectation average operator, σ is a sigmoid function, β is a temperature parameter, aₜ is a plan of steps associated with the instruction executed in the updated initial model policy, hₜ is the history of the executed plan and the context of the executed plan, π_{θ} is the updated initial model policy, π_{ref} is the initial model policy, t is an iteration number.

3. The method of claim 1, wherein the one or more agents comprise:
entities configured to perform actions in an environment.

4. The method of claim 1, further comprising:
filtering the replay buffer based on a reward model.

5. The method of claim 1, further comprising:
filtering the replay buffer based on a verifier.

6. The method of claim 1, further comprising:
iteratively refining the updated initial model policy based on a guided search strategy.

7. The method of claim 6, wherein the guided search strategy comprises:
selecting each node in each of the trajectories;
generating a pre-selected number of completions for each node based on the updated initial model policy;
rolling out each of the trajectories based on the updated initial model policy until a terminal state is reached;
receiving a reward when the terminal state is reached; and
backpropagating the reward multiplied by a discount factor based on
$$\begin{matrix}Q ( {s}_{t} , a ) ← \frac{Q ( {s}_{t} , a ) N ( {s}_{t} , a ) + {γ}^{T - t} R}{N ( {s}_{t} , a ) + 1} \\ N ( {s}_{t} , a ) ← N ( {s}_{t} , a ) + 1\end{matrix} ,$$
where γ is the discount factor, s is a state, R is one of the trajectories, Q is the reward for passing through the state, a is an action, N(St, a) is the number of times a state-action pair was visited during a search.

8. The method of claim 7, further comprising:
producing a feedback score for the action based on a ranking of how much the action helped complete the instruction.

9. The method of claim 8, further comprising:
computing a score for the node based on the feedback score and the reward.

10. The method of claim 1, wherein the optimized model policy comprises:
a policy for one or more of a language model, a vision model, an audio model, a video model, an image model, a physical data model, or a haptic model.

11. The method of claim 1, wherein the optimized model policy is based on an off-policy variant of a Direct Preference Optimization algorithm.

12. The method of claim 1, further comprising:
aggregating data from each of the trajectories in the replay buffer,
wherein the replay buffer is off-policy.

13. A computer system for generating an optimized model policy for one or more agents, the computer system comprising:
a hardware processor; and
a non-volatile storage medium storing instructions that when executed by the hardware processor perform operations comprising:
(a) receiving an initial model policy, a replay buffer of trajectories, and an instruction;
(b) determining a number of the trajectories for each instruction using the initial model policy;
(c) constructing preference pairs at each node in each of the trajectories;
(d) adding the preference pairs to the replay buffer;
(e) updating the initial model policy creating an updated initial model policy based on the replay buffer, an executed plan of steps associated with the instruction executed in the updated initial model policy, a history of the executed plan and context of the executed plan, and the initial model policy; and
(f) repeating steps (b)-(e) for a number of iterations to generate the optimized model policy based on the updated initial model policy.

14. The computer system of claim 13, wherein updating the initial model policy is based on
$${ℒ}_{DPO} ( {π}_{θ} ; 𝒟 ) = - {𝔼}_{( {T}_{ω} , {T}_{l} ) \sim 𝒟} [ og σ ( ( {\sum }_{t = 0}^{{i}_{⊤} ω - 1} β log \frac{{π}_{θ} ( {a}_{t}^{ω} \vert {h}_{t}^{ω} )}{{π}_{ref} ( {a}_{t}^{ω} \vert {h}_{t}^{ω} )} ) - ( {\sum }_{t = 0}^{{i}_{⊤} ↓ - 1} β log \frac{{π}_{θ} ( {a}_{t}^{l} \vert {h}_{t}^{l} )}{{π}_{ref} ( {a}_{t}^{l} \vert {h}_{t}^{l} )} ) ) ]$$
where D is the replay buffer of the trajectories, E is an expectation average operator, σ is a sigmoid function, β is a temperature parameter, aₜ is a plan of steps associated with the instruction executed in the updated initial model policy, hₜ is the history of the executed plan and the context of the executed plan, π_{θ} is the updated initial model policy, π^{ref} is the initial model policy, t is an iteration number.

15. The computer system of claim 13, wherein the one or more agents comprise:
entities configured to perform actions in an environment.

16. The computer system of claim 13, further comprising:
filtering the replay buffer based on a reward model.

17. The computer system of claim 13, further comprising:
filtering the replay buffer based on a verifier.

18. The computer system of claim 13, further comprising:
iteratively refining the optimized model policy based on a guided search strategy.

19. The computer system of claim 18, wherein the guided search strategy comprises:
selecting each node in each of the trajectories;
generating a pre-selected number of completions for each node based on the optimized model policy;
rolling out each of the trajectories based on the optimized model policy until a terminal state is reached;
receiving a reward when the terminal state is reached; and
backpropagating the reward multiplied by a discount factor based on
$$\begin{matrix}Q ( {s}_{t} , a ) ← \frac{Q ( {s}_{t} , a ) N ( {s}_{t} , a ) + {γ}^{T - t} R}{N ( {s}_{t} , a ) + 1} \\ N ( {s}_{t} , a ) ← N ( {s}_{t} , a ) + 1\end{matrix} ,$$
where γ is the discount factor, s is a state, R is one of the trajectories, Q is the reward for passing through the state, a is an action, N is the number of times a state-action pair was visited during a search.

20. A computer program product for generating an optimized model policy for one or more agents, the computer program product comprising a computer readable storage medium having program instructions embodied therewith, the program instructions executable by a computing device to cause the computing device to perform operations comprising:
(a) receiving an initial model policy, a replay buffer of trajectories, and an instruction;
(b) determining a number of the trajectories for each instruction using the initial model policy;
(c) constructing preference pairs at each node in each of the trajectories;
(d) adding the preference pairs to the replay buffer;
(e) updating the initial model policy creating an updated initial model policy based on the replay buffer, an executed plan of steps associated with the instruction executed in the updated initial model policy, a history of the executed plan and context of the executed plan, and the initial model policy;
(f) repeating steps (b)-(e) for a number of iterations to generate the optimized model policy based on the updated initial model policy;
(g) filtering the replay buffer based on a reward model or a verifier;
(h) iteratively refining the updated initial model policy based on a guided search strategy;
(i) producing a feedback score for each action based on a ranking of how much the action helped complete the instruction;
(j) computing a score for a node based on the feedback score and a reward; and
(k) aggregating data from the trajectory in the replay buffer, wherein the replay buffer is off-policy,
wherein
updating the initial model policy is based on
$${ℒ}_{DPO} ( {π}_{θ} ; 𝒟 ) = - {𝔼}_{( {T}_{ω} , {T}_{l} ) \sim 𝒟} [ og σ ( ( {\sum }_{t = 0}^{{i}_{⊤} ω - 1} β log \frac{{π}_{θ} ( {a}_{t}^{ω} \vert {h}_{t}^{ω} )}{{π}_{ref} ( {a}_{t}^{ω} \vert {h}_{t}^{ω} )} ) - ( {\sum }_{t = 0}^{{i}_{⊤} ↓ - 1} β log \frac{{π}_{θ} ( {a}_{t}^{l} \vert {h}_{t}^{l} )}{{π}_{ref} ( {a}_{t}^{l} \vert {h}_{t}^{l} )} ) ) ]$$
where D is the replay buffer of the trajectories, E is an expectation average operator, σ is a sigmoid function, β is a temperature parameter, a, is a plan of steps associated with the instruction executed in the updated initial model policy, hₜ is the history of the executed plan and the context of the executed plan, π_{θ} is the updated initial model policy, π_{ref} is the initial model policy, t is an iteration number, the one or more agents comprise entities configured to perform actions in an environment,
the optimized model policy comprises one or more of a language model, a vision model, an audio model, a video model, an image model, a physical data model, or a haptic model,
the optimized model policy is based on an off-policy variant of a Direct Preference Optimization algorithm, and
the guided search strategy includes:
selecting the nodes in each of the trajectories;
generating a pre-selected number of completions for each of the nodes based on the updated initial model policy;
rolling out each of the trajectories based on the updated initial model policy until a terminal state is reached;
receiving the reward when the terminal state is reached; and
backpropagating the reward multiplied by a discount factor based on
$$\begin{matrix}Q ( {s}_{t} , a ) ← \frac{Q ( {s}_{t} , a ) N ( {s}_{t} , a ) + {γ}^{T - t} R}{N ( {s}_{t} , a ) + 1} \\ N ( {s}_{t} , a ) ← N ( {s}_{t} , a ) + 1\end{matrix} ,$$
where γ is the discount factor, s is a state, R is one of the trajectories, Q is the reward for passing through the state, a is an action, N is the number of times a state-action pair was visited during a search.
